(19) United States
(12) Patent Application Publication
(10) Pub. No.: US 2026/0244948 A1
(43) Pub. Date: Aug. 20, 2026

(54) Platform for Canonical Retrieval Tokenization, Proof Conditioned Monetization, Autonomous Agent Orchestration, and GPU Accelerated Deterministic Scoring

(71) Applicant: dario chang, Doral, FL (US)

(72) Inventor: dario chang, Doral, FL (US)

(21) Appl. No.: 19/640,767

(22) Filed: Apr. 7, 2026

Related U.S. Application Data
(63) Continuation-in-part of application No. 19/331,115, filed on Sep. 17, 2025.
(63) Continuation-in-part of application No. 19/291,647, filed on Aug. 6, 2025, now abandoned.

(51) Int. Cl. G06N 5/022

(52) U.S. Cl. CPC G06N 5/022

(57) ABSTRACT

A platform issues canonical Importance Prediction Score tokens at retrieval boundaries to enable proof-conditioned monetization and verifiable micro-markets. Canonical tokens are deterministically serialized and hashed to produce provenance digests that are batched into Merkle trees and anchored to one or more ledgers. A Proof Registry ingests heterogeneous proof families and indexed proof descriptors. A composite proof verifier normalizes confidences, applies configurable market weight profiles, and emits composite verification records that gate monetization and trigger an adaptive settlement engine. The settlement engine executes deterministic atomic commits across settlement rails and issues cryptographically signed settlement finality proofs. A Rotation Gateway enforces cluster-level exposure and cooldown policies. GPU-accelerated deterministic scoring with model elasticity preserves canonicalization for auditor replay. Adapter interfaces integrate retrieval engines, proof systems, and settlement rails. Video-specific embodiments include frame hashing, segment anchoring, ad-pod metadata, and viewability windows. Regulator APIs support selective disclosure and deterministic replay while preserving privacy.

### CROSS REFERENCE TO RELATED APPLICATIONS AND PRIORITY STATEMENT

This application is a Continuation-in-Part of U.S. application Ser. No. 10/605,894, filed Nov. 4, 2003; U.S. application Ser. No. 19/291,647, filed Aug. 26, 2025; and U.S. application Ser. No. 19/331,115, filed Sep. 17, 2025. Each of the foregoing applications is incorporated herein by reference in its entirety. Applicant claims priority to subject matter supported in the parent applications to the extent permitted by law. This application contains new matter not present in the parent applications.

### FIELD OF THE INVENTION

This disclosure relates to computer-implemented systems and methods for retrieval-boundary canonical tokenization, verifiable provenance, composite proof verification, adaptive settlement orchestration, autonomous agent orchestration, and GPU-accelerated deterministic scoring with model elasticity.

### BACKGROUND OF THE INVENTION

Modern retrieval and monetization pipelines require auditable provenance, low-latency proofing at scale, and deterministic canonicalization to enable reproducible auditor replay and regulator-friendly selective disclosure.

Prior systems commonly separate scoring, proofing, and settlement and often lack GPU-native implementations that preserve determinism for canonicalization, attestation, and Merkle anchoring.

Earlier filings in this family introduced primitives such as Cycle Hits, Hits History, rotation groups, and interactive multimedia Ads. The present disclosure maps those primitives to modern canonical token and proof architectures and adds GPU-accelerated deterministic scoring, adapter interfaces, and video-specific anchoring.

### SUMMARY OF THE INVENTION

The invention issues canonical Importance Prediction Score tokens at retrieval boundaries, anchors provenance via Merkle roots, supports heterogeneous proof families and sampled proofing strategies, computes composite verification scores using configurable weight profiles, conditions monetization on settlement finality proofs, and provides adapter interfaces to integrate with retrieval engines and proof systems.

The invention further provides GPU-accelerated deterministic scoring and model elasticity mechanisms optimized for superchip architectures while preserving deterministic outputs used in canonical tokens.

Video-specific embodiments include frame hashing, video segment digests, ad-pod metadata, viewability windows, and selective disclosure mechanisms enabling auditor replay without transmitting raw video content.

### DEFINITIONS

“Retrieval Engine Candidate Set” means the set of candidate assets returned by a retrieval engine for a given impression, query, or retrieval request.

“Importance Prediction Score” or “IPS” means a numeric or categorical score predicting the importance, relevance, or monetizable value of a candidate for a given retrieval context.

“IPS Token” means a canonicalized, signed data structure containing an Importance Prediction Score and provenance pointers.

“Provenance Digest” means a collision-resistant hash of canonicalized token bytes.

“Proof Registry” means a tamper-evident store that indexes proof descriptors, verifier receipts, Merkle leaf pointers, and anchoring references.

“Verifier Receipt” means a signed artifact returned by a proof verifier indicating proof validation, confidence values, and anchoring references.

“Composite Verification Score” means a weighted aggregation of normalized confidence values derived from multiple proof families and attestations.

“Rotation Group” means an internal grouping identifier used to apply rotation, cooldown, and unlisting policies at candidate or cluster granularity.

“Model Elasticity” means runtime mechanisms to adjust model precision, width, replication, or slicing to trade accuracy for latency or cost while preserving deterministic outputs for canonicalization.

“Anchoring Ref” means a ledger reference returned when a Merkle root or other anchoring artifact is published to a ledger, the anchoring ref including at least a ledger identifier and transaction identifier.

### DETAILED DESCRIPTION OF THE INVENTION

### Canonical Token Morphology and Deterministic Serialization

Canonical tokens are generated by serializing a canonical token schema in a fixed canonical order to produce canonical_bytes. Example canonical field order includes: ips_token_id; candidate_identifier; timestamp; issuer_id; ips_value; viewability_score; dwell_time_ms; rotation_group; confidence_interval; freshness_score; market_metadata.

Numeric fields are serialized with fixed precision and stable rounding rules. Text fields are UTF-8 encoded. Arrays are sorted using stable tie-breaking rules. Object keys are ordered deterministically prior to serialization.

The serialized canonical_bytes are hashed using a collision-resistant hash function, for example SHA-256, to produce a provenance_digest. Implementations may follow a JSON canonicalization scheme such as RFC8785 or an equivalent deterministic canonicalization scheme. Pseudocode and test vectors are provided to enable reproducible implementation.

### Retrieval Boundary Tokenization and Provisional Receipts

At the retrieval boundary, a RetrievalAdapter accepts a candidate_set and invokes a Tokenizer to produce an IPS token for each candidate. The Tokenizer maps retrieval fields to canonical token fields using a canonical mapping table specifying retrieval_field→canonical_field mappings and deterministic tie-breaking rules.

When synchronous proofing is infeasible, the system issues provisional_receipts that include ips_token_id, candidate_identifier, provenance_digest, timestamp, issuer_id, and a proof_pending flag. Provisional receipts are signed by the issuer and recorded in append-only logs to preserve auditability.

### Proof Registry, Indexed Proof Descriptors, and Merkle Anchoring

The Proof Registry is a tamper-evident store that accepts heterogeneous proof artifacts and indexed proof descriptors. Each descriptor includes at least proof_type, issuer_id, issuance_time, confidence_value, jurisdiction, disclosure_descriptor, and merkle_leaf_pointer.

Provenance_digests are batched into Merkle leaves (L_i=\text{HASH} (\text{UTF8}(\text{CanonicalJSON}(token_i)))). A Merkle root R is computed and published to one or more ledgers returning an anchoring_ref comprising ledger_id and tx_id. Verifier_receipts include merkle_proof and anchoring_ref enabling tamper-evident auditor replay.

The Proof Registry stores verifier_receipts, proof descriptors, anchoring_refs, and metadata enabling selective disclosure and auditor replay without transmitting raw personal or content data.

### Composite Proof Verification and Monetization Gating

A composite proof verifier normalizes confidence values from multiple proof families, applies market weight profiles stored as market policy records, optionally trims outliers, and computes a composite_verification_score. Aggregation options include trimmed mean, median, weighted sum with outlier trimming, conformal prediction calibration, or Bayesian ensembling.

When the composite_verification_score meets or exceeds a configurable market threshold, the verifier emits a composite_verification_record. Monetization, settlement, or value transfer for a canonical token is conditioned on recording a composite_verification_record and issuance of a settlement_finality_proof that references one or more verifier_receipts and anchoring_refs.

### Adaptive Settlement Engine and Atomic Commit Semantics

The Adaptive Settlement Engine listens for composite_verification_records and, upon threshold satisfaction, prepares settlement_intents, coordinates participant acknowledgements, executes an atomic commit protocol across one or more settlement rails (for example two-phase commit across heterogeneous ledgers or escrow smart contracts), and issues a cryptographically signed settlement_finality_proof.

Settlement receipts include provenance_digest_list, composite_verification_score, settlement_finality_proof, timestamp, participants, and finality_signature. Settlement receipts and finality proofs are recorded in the Proof Registry and referenced by anchoring_refs.

### Rotation Gateway and Cluster Enforcement

The Rotation Gateway maps external semantic cluster identifiers (Entity IDs) to internal rotation_group identifiers and enforces rotation, cooldown, and unlisting policies at cluster granularity. Enforcement actions are recorded as signed state envelopes containing cluster_entity_id, old_state, new_state, timestamp, nonce, state_digest, issuer_pubkey, and signature.

Cross-network propagation of cluster state changes may require quorum acknowledgements and Merkle-anchored proofs prior to commit. Rotation policies may be parameterized by exposure limits, cooldown windows, fairness constraints, and regulatory constraints.

### Sampling, Precomputation, and Auditor Replay

Sampling policies select a subset of candidates for full cryptographic proofing based on configurable sampling_rate, IPS stratification, or risk signals. Precomputation strategies include incremental witness updates, cached proof fragments, and Trusted Execution Environment presignatures.

Verifier_receipts referencing anchoring_refs are published asynchronously when proofs complete. Regulator APIs support deterministic replay of sampled proof traces within secure sandboxes under role-based disclosure constraints.

### GPU-Accelerated Deterministic Scoring and Model Elasticity

Deep neural networks are optimized for superchip architectures using mixed precision, tensor core kernels, NVLink-aware sharding, and HBM-optimized layouts. To preserve determinism for canonicalization, inference runs that produce canonical token fields must fix numeric rounding modes, disable nondeterministic operators, and record precision_mode, kernel_version, and model_shard_map in verifier_receipts.

Model elasticity mechanisms include vertical scaling (precision/width adjustment), horizontal scaling (replica coordination with deterministic routing), and model slicing (prefix layers for low-cost scoring and full model for proofing). Elasticity decisions and profile identifiers are recorded in canonical tokens and verifier_receipts.

Deterministic execution requirements include fixed random seeds where stochastic operators are used for non-canonical outputs, deterministic tie-breaking rules for equal scores, and recording of execution environment metadata sufficient to reproduce canonical outputs.

### Adapter Interfaces and Retrieval Integration

Versioned adapter interfaces including RetrievalAdapter, TokenizerAdapter, ProofAdapter, and SettlementAdapter map retrieval generation fields to canonical token fields via a canonical mapping table. Adapters expose hooks for retrieval engines to request low-cost model slices for initial ranking and full model proofing for top candidates and to subscribe to composite_verification_records for proof-conditioned monetization.

Adapter interfaces record adapter_version, retrieval_generation metadata, and mapping tables in canonical tokens and verifier_receipts to enable cross-generation compatibility and auditor replay.

### Selective Disclosure and Regulator Apis

Disclosure_descriptors enumerate allowed revealed fields for selective disclosure. The regulator API, given an authenticated auditor query and a disclosure_descriptor, returns selective_disclosure_payloads and Merkle proof paths without transmitting raw personal data. Auditor queries and regulator API responses are recorded as tamper-evident artifacts in the Proof Registry.

### Reputation, Fraud Prevention, and Human-in-the-loop Gating

Reputation scores are computed from historical proof outcomes, dispute records, and SLA performance. An Adversarial Robustness Pipeline computes verifier reputation, detects anomalous patterns, applies staking and slashing rules, and issues quarantine actions. Composite_verification_records that fail fairness or adversarial robustness checks trigger human-in-the-loop gating; gating decisions are recorded as tamper-evident audit entries.

### Developer Tooling, Certification, and Portfolio Provenance Tokens

SDKs, certification test harnesses, and simulation sandboxes implement APIs for token minting, proof submission, proof validation, composite score configuration, and settlement orchestration. Portfolio Provenance Tokens represent bundles of compliance attestations and certification badges; minting, revocation, and update events are recorded in the Proof Registry linked to provenance_digest values.

### Cross-Chain Mapping and Interoperability

For cross-chain settlement, canonical token identifiers and provenance_digest values are mapped across ledgers by bridge modules that preserve Merkle pointers. Cross-chain commit semantics ensure consistent settlement and record cross-chain finality proofs in the Proof Registry.

### Video-Specific Embodiments

For video candidates, canonical IPS tokens include frame_hash and video_segment_digest values computed by canonicalizing and hashing representative frames or frame aggregates. Frame_hash and video_segment_digest values are included in the provenance_digest computation.

Canonical tokens for video candidates include video_ad_metadata comprising ad_pod_id, ad_break_position, creative_id, and ad_slot_duration_ms. Rotation_group mapping and rotation policies apply at ad_pod granularity to control exposure and cooldown across ad pods.

Canonical tokens for video candidates include viewability_window_ms and playback_metrics fields comprising view_time_ms, percent_viewed, playback_start_offset_ms, and playback_end_offset_ms. Freshness_score and viewability_score are computed from these playback metrics and recorded in the canonical token.

Merkle leaves may include video_segment_digest values for each anchored video segment. The Merkle root anchors both IPS tokens and video segment digests to a ledger, and verifier_receipts include segment_proof_paths enabling tamper-evident verification of specific video frames or segments without transmitting raw video content.

Sampling policies for video candidates select segments or frames for full cryptographic proofing based on viewability thresholds, creative_id risk signals, or rotation_group status. Regulator APIs enable deterministic replay of sampled video proof traces within secure sandboxes while returning selective_disclosure_payloads that omit raw video frames.

### Enablement and Best Practices

The specification provides pseudocode, canonicalization examples, Merkle leaf construction rules, verifier_receipt JSON schemas, GPU tuning examples, and test vectors sufficient for a person of ordinary skill in the art to implement the described embodiments without undue experimentation.

Determinism is preserved by disabling stochastic operators or fixing seeds for inference runs used in canonical token generation. Fallback modes for non-superchip deployments are described and must record fallback_profile_id in canonical tokens.

Example pseudocode for canonicalization, Merkle leaf construction, and verifier receipt generation is provided to illustrate deterministic serialization, hashing, and anchoring workflows.

### Industrial Applicability and Use Cases

The platform is applicable to retrieval and monetization systems, programmatic advertising, video ad platforms, search and recommendation systems, marketplace settlement systems, and auditor/regulator workflows requiring tamper-evident provenance and verifiable settlement.

Representative use cases include: gating monetization on proof finality for ad impressions, anchoring video segment proofs for royalty settlement, enforcing rotation policies across ad pods, and providing regulator APIs for selective disclosure and deterministic replay.

### Examples and Implementation Notes

Example 1 describes a retrieval pipeline where a retrieval engine returns a candidate_set, the Tokenizer generates canonical IPS tokens, provisional_receipts are issued, sampled candidates are proofed asynchronously, Merkle roots are anchored, and settlement_finality_proofs are issued upon composite verification.

Example 2 describes a video ad flow where frame_hash and video_segment_digest values are computed for representative frames, Merkle leaves include segment digests, sampled segments are proofed, and regulator APIs enable auditor replay without exposing raw frames.

Example 3 describes GPU-accelerated scoring where model slicing is used for low-cost initial ranking and full model proofing for top candidates, with deterministic execution metadata recorded in verifier_receipts.

### Claims Support and Priority Mapping Statement

Applicant intends to claim priority to the parent applications for subject matter supported therein. For claim elements supported by earlier filings, applicant will assert priority to the earliest supporting filing. New matter introduced in this application is entitled to the filing date of this application.

### Closing Statement

The foregoing description is illustrative and not limiting. Variations, substitutions, and equivalents that perform substantially the same functions in substantially the same way to achieve substantially the same results are within the scope of the invention.

### Appendix and Example Data Schemas (non-limiting)

Example canonical token JSON schema, verifier_receipt JSON schema, Merkle leaf construction pseudocode, and sample test vectors are provided in an appendix to enable reproducible implementation and examiner review. The appendix includes canonical field ordering examples, numeric serialization precision rules, and sample anchoring_ref formats.

1. A computer-implemented system comprising one or more processors and non-transitory memory storing instructions that, when executed, cause the processors to:
receive, from a retrieval engine, a candidate set comprising a plurality of candidate identifiers and associated retrieval feature vectors;
for each candidate, compute an Importance Prediction Score by fusing behavioral, historical, and contextual signals including Cycle Hits and Hits History primitives;
generate, for each candidate, a canonical IPS token by serializing a defined canonical field set in a fixed canonical order and computing a provenance_digest equal to a collision-resistant hash of the serialized bytes;
record or reference verifiable proof artifacts for at least a subset of the canonical IPS tokens in a Proof Registry that stores indexed proof descriptors and Merkle leaf pointers;
compute a composite_verification_score by normalizing confidence values from multiple proof families and applying a market weight profile; and
condition monetization, settlement, or value transfer for a candidate on issuance of a composite_verification_record and a settlement_finality_proof that references one or more verifier_receipts and anchoring_refs.

2. A computer-implemented system comprising one or more processors and non-transitory memory storing instructions that, when executed, cause the processors to:
perform Importance Prediction Score computation using deep neural network models optimized for GPU-accelerated architectures;
produce inference outputs deterministically for use in canonical token generation by fixing numeric rounding modes, disabling nondeterministic operators, and recording execution metadata including model_version, precision_mode, kernel_version, and model_shard_map in verifier_receipts; and
support model elasticity including vertical scaling, horizontal scaling, and model slicing, and record an elasticity_profile_id in canonical tokens and verifier_receipts.

3. A computer-implemented system for video-specific retrieval tokenization comprising:
a canonical IPS token structure that includes at least a frame_hash and a video_segment_digest computed by canonicalizing and hashing one or more representative frames or frame aggregates from a candidate video;
a Merkle anchoring module that batches provenance_digests and video_segment_digest values into Merkle leaves and publishes a Merkle root to a ledger returning an anchoring_ref;
a Rotation Gateway that applies rotation_group policies at ad_pod granularity including ad_pod_id and ad_break_position to control exposure and cooldown across ad pods; and
a regulator API that, given an authenticated auditor query and a disclosure_descriptor, returns selective_disclosure_payloads and Merkle proof paths enabling deterministic replay of sampled video proof traces without transmitting raw video frames.

4. The system of claim 1, further comprising a Rotation Gateway that maps external semantic cluster identifiers to internal rotation_group identifiers, issues signed state envelopes containing cluster_entity_id, old_state, new_state, timestamp, state_digest, issuer_pubkey, and signature, and requires quorum acknowledgements and Merkle-anchored proofs prior to cross-network propagation of cluster state changes.

5. The system of claim 1, wherein canonicalization uses a JSON canonicalization scheme and numeric fields are serialized with fixed decimal precision and object keys are sorted lexicographically prior to serialization, and wherein provenance_digest=SHA-256(UTF-8(canonical_bytes)).

6. The system of claim 1, wherein provenance_digests are batched into Merkle leaves (L_i=\text{SHA-256}(\text{UTF-8}(\text{CanonicalJSON}(token_i)))), a Merkle root R is computed, and R is published in a ledger transaction returning an anchoring_ref comprising ledger_id and tx_id, and wherein verifier_receipts reference anchoring_ref and include Merkle proof paths enabling tamper-evident auditor replay.

7. The system of claim 1, wherein a verifier_receipt comprises receipt_id, proof_id, verifier_id, timestamp, result, merkle_proof, anchoring_ref, model_version, precision_mode, and elasticity_profile_id.

8. The system of claim 1, wherein the composite_verification_score is computed by normalizing raw confidence values (r_i) to (c_i=(r_i-r_{min})/(r_{max} r_{min})), applying market weights (w_i) summing to 1, optionally trimming a configurable percentage of outliers, and computing (C=\sum_i w_i\cdot c_i).

9. The system of claim 1, wherein provisional_receipts with a proof_pending flag are issued synchronously while full proofs are computed asynchronously for a sampled subset of candidates selected according to a configurable sampling policy, and wherein verifier_receipts referencing anchoring_refs are published when proofs complete.

10. The system of claim 1, wherein a regulator API, given an authenticated auditor query and a disclosure_descriptor enumerating allowed fields, returns selective_disclosure_payloads and Merkle proof paths without transmitting raw personal data.

11. The system of claim 2, wherein deterministic execution for canonical token fields is preserved by fixing random seeds for any stochastic operators used for non-canonical outputs, applying deterministic tie-breaking rules for equal scores, and recording execution environment metadata sufficient to reproduce canonical outputs.

12. The system of claim 2, wherein model elasticity comprises: vertical scaling by adjusting numeric precision or model width; horizontal scaling by coordinating replicas with deterministic routing; and model slicing by executing prefix layers for low-cost scoring and full model layers for proofing, and wherein elasticity decisions are recorded in verifier_receipts.

13. The system of claim 3, wherein canonical tokens for video candidates include viewability_window_ms and playback_metrics fields comprising view_time_ms, percent_viewed, playback_start_offset_ms, and playback_end_offset_ms, and wherein freshness_score and viewability_score are computed from these playback metrics and recorded in the canonical token.

14. The system of claim 3, wherein Merkle leaves include video_segment_digest values for each anchored video segment, the Merkle root R anchors both IPS tokens and video segment digests to a ledger, and verifier_receipts include segment_proof_paths enabling tamper-evident verification of specific video frames or segments without transmitting raw video content.

15. The system of claim 1, further comprising a Joint Compute Value Score engine that computes a composite compute/cost score from telemetry including latency, energy consumption, memory usage, and carbon intensity, and wherein the JCVS value is recorded in canonical tokens and exposed as a placement or routing signal.

16. The system of claim 1, further comprising reputation and fraud prevention modules that compute reputation scores from historical proof outcomes, dispute records, and SLA performance and that record slashing or revocation events in the Proof Registry linked to participant identifiers.

17. The system of claim 1, wherein canonical tokens are bound to Trusted Execution Environment attestation tokens comprising enclave_measurement, ips_token_digest, report_binding, signer_pubkey, timestamp, and signature, and wherein the Proof Registry verifies the attestation prior to accepting proof artifacts.

18. The system of claim 1, wherein adapters comprising a RetrievalAdapter, TokenizerAdapter, ProofAdapter, and SettlementAdapter map retrieval generation fields to canonical token fields using a canonical mapping table specifying retrieval_field to canonical_field mappings and deterministic tie-breaking rules, and wherein adapters record adapter_version and retrieval_generation metadata in canonical tokens and verifier_receipts to enable cross-generation compatibility.

19. The system of claim 1, wherein settlement_finality_proof includes settlement_id, provenance_digest_list, composite_verification_score, participants, finality_signature, and timestamp, and wherein settlement receipts are recorded in the Proof Registry and referenced by anchoring_refs.

20. A non-transitory computer readable medium storing instructions that, when executed by one or more processors, cause the processors to perform the operations of any one of claims 1-19.
